(19) United States
(12) Patent Application Publication
(10) Pub. No.: US 2021/0008611 A1
(43) Pub. Date: Jan. 14, 2021

(54) PRESS DIE FOR A PRESSING TOOL FOR PRESSING ROUND TUBULAR WORKPIECE SECTIONS

(71) Applicant: ROTHENBERGER AG, Kelkheim (DE)

(72) Inventors: Thoralf Krause, Leipzig (DE); Maximilian Gottschalk, Eltville (DE); Markus Bücker, Roßdorf (DE)

(73) Assignee: ROTHENBERGER AG, Kelkheim (DE)

(21) Appl. No.: 16/643,863

(22) PCT Filed: Aug. 31, 2018
(86) PCT No.: PCT/DE2018/100745

§ 371 Date: Mar. 3, 2020

(30) Foreign Application Priority Data
Sep. 4, 2017 (DE) 10 2017 120 327.3
Oct. 9, 2017 (DE) 10 2017 123 362.8

(51) Int. Cl. B21D 39/04

(52) U.S. Cl. CPC B21D 39/048

(57) ABSTRACT

A press die for a pressing tool for pressing round tubular sections of at least two workpieces has a through-hole with a circumferential die surface. It includes at least two die parts. Each of the at least two die parts comprises a circumferential section of the through-hole. At least one of the die parts comprises a round target contour over at least one region of the associated circumferential section of the through-hole. At least one other die part comprises a contour deviating from the round target contour over at least one region of the associated circumferential section of the through-hole. Thus, the circumferential sections of the through-hole associated with the at least two die parts are asymmetrical relative to each other with respect to a chord formed by the associated circumferential section of the through-hole.

### TECHNICAL FIELD

The disclosure relates to a press die for pressing round tubular sections of at least two workpieces. The disclosure also relates to a pressing tool with such a press die. In addition, the disclosure relates to a method for producing a pressed connection of round tubular sections of at least two workpieces and a method for manufacturing a press die.

### BACKGROUND

Press dies of the type mentioned here are used, among other things, in pressing tools, for example, to press round tubular workpieces to form a tube joint. Such workpieces are, for example, press fittings, which are pressed by means of the pressing tools with ends of tubes and serve as connecting pieces in a pipeline. The press fittings, for example, consist of a relatively easily deformable material, such as copper, brass or plastic. The tubes can be copper, steel or multi-layer composite tubes.

Pressing is usually carried out in such a manner that the pressing tool exerts a high pressing force acting radially on the entire circumference of the press fitting, resulting in a press connection of the fitting to the tube due to a targeted material deformation. The press die of the pressing tool plays a decisive role here, since it is the press die that determines the material deformation and thus the quality of the press connection. When designing the die surface of the press die, the shape and diameter of the workpieces to be connected are usually taken into account in order to achieve a press connection that meets requirements; for example, to achieve a media-impermeable press connection and/or a torsionally rigid fit of the press fitting on the tube.

### SUMMARY

It is a task of the disclosure to provide a press die of the type mentioned above, by which a torsionally rigid fit of the round tubular sections of workpieces pressed therewith is promoted in relation to each other. Moreover, a pressing tool should be provided, which is suitable for the use of such a press die. In addition, a method for the manufacture of such a press die and a method for producing a press connection of round tubular sections of at least two workpieces by means of such a press die is to be proposed.

The task is achieved with a press die as claimed. Advantageous embodiments and/or arrangements and/or aspects are disclosed in the following description and the figures.

A basic press die, for example for a pressing tool for pressing round tubular sections of at least two workpieces, comprises a front side, a rear side and a through-hole extending from the front side to the rear side. In particular, the rear side is arranged opposite the front side. The through-hole comprises a front opening at the front side and a rear opening at the rear side. Furthermore, the through-hole comprises a circumferential surface, which is formed as a die surface and in particular serves as a mold for the workpieces to be pressed.

The press die is constructed in several parts by at least two die parts, in particular die segments, and comprises at least one, preferably two closing points. Each of the closing points is formed by mutually associated end faces of mutually adjacent die parts of the at least two die parts, and each of the at least two die parts comprises a circumferential section of the through-hole, preferably over an angle of circumference, such that, in a closing position of the at least two die parts at the closing points, the circumferential surface of the through-hole is assembled on the circumference.

According to one embodiment, it is provided that at least one of the die parts comprises a round target contour, in particular a circular target contour, over at least one subsection of the associated circumferential section of the through-hole, and the at least one other die part comprises a contour deviating from the round target contour over at least one subsection of the associated circumferential section of the through-hole, such that the circumferential sections of the through-hole associated with the at least two die parts are asymmetrical to each other with respect to a chord formed by the associated circumferential section of the through-hole.

The target contour, which is formed to be round, is based on the round cross-sectional shape of the workpieces to be pressed. Thereby, at least in the area with the round target contour, the pressing of the round tubular sections of the workpieces to be pressed can be realized with no or at most only a slight degree formation. Due to the contour deviating from the round target contour, at least the outer round tubular section of one workpiece to be pressed is pressed into a form over one area on the outer circumference, by means of which a rotation of the round tubular sections of the work pieces being pressed relative to each other is made more difficult. In this respect, the area of the press die with the contour deviating from the round target contour forms or shapes, as the case may be, a contour on the workpieces to be pressed, which promotes a rotationally rigid fit of the workpieces relative to each other. Thus, a measure for the formation of an anti-rotation protection on at least one of the workpieces to be pressed is realized. For example, the round tubular sections of the workpieces are only to be deformed during pressing to such an extent that both sections have a contour deviating from the round contour at least partially over the circumferential area under consideration, or at least approximately. In particular, this provides an anti-rotation protection by means of the positive locking of the round tubular sections pressed against each other.

By assigning the area with the round contour to one part of the die and the area with the deviating contour to the other part of the die, and through the asymmetrical arrangement of these areas in relation to each other, a measure has also been taken, which measure is based on a technically simple manufacture of the press die despite these two different contours. This is because it makes it possible to consider only one of the two contours when manufacturing the die parts for the respective die part.

With regard to the asymmetrical arrangement of the round contour in relation to the contour deviating from it, in the course of the description, the term “chord” is to be understood in particular as the connecting section or connecting plane between the end faces adjacent to the circumferential section of the through-hole. Thus, the chord is to be understood as the connecting line or connecting plane that connects the ends on the circumferential side of the circumferential section of the through-hole forming the die face of a respective die part.

It can be provided that the contour deviating from the round target contour is straight. This provides a contour that is technically relatively easy to manufacture, which promotes the desired torsionally rigid fit with the pressed workpieces. For example, the round tubular sections of the workpieces are only to be deformed during pressing to such an extent that both sections have a linear or almost linear shape at least partially over the circumferential area under consideration. In particular, this provides an anti-rotation protection by means of the positive locking of the round tubular sections pressed against each other.

It can also be provided that the contour deviating from the target round contour forms at least one side of a polygon, wherein at least part of the polygon forms the circumferential section of the through-hole, which is enclosed by the at least one other die part, i.e. the die part with the contour deviating from the round contour. Due to the angular design of the contour deviating from the round contour, an additional measure has been taken, which measure promotes the desired torsionally rigid fit with the pressed round tubular sections. For example, the polygon is a hexagon, and the circumferential section of the through-hole formed by the at least one other die portion includes at least three sides of the hexagon, at least partially. In particular, the polygon or hexagon can be a rounded polygon or a rounded hexagon.

In one possible arrangement and/or embodiment of the press die, the round target contour can be interrupted by an area with a contour deviating from it. In this manner, the at least one die part with the round contour also supports the formation of the torsionally rigid fit, if the round tubular sections of the workpieces are pressed against each other. For example, the additional contour deviating from the round target contour is straight. This results in the same advantages as described above for the straight-line contour. For example, the contour deviating from the round target contour is arranged parallel to and spaced apart from the chord of the associated at least one die part.

With an additional possible arrangement and/or embodiment of the press die, it is provided that the round target contour is provided over at least one subsection of the associated circumferential section of the through-hole that adjoins one of the end faces of the at least one other die part, and the contour deviating from the round target contour is provided over at least one subsection of the associated circumferential section of the through-hole that adjoins the corresponding end face of the at least one other die part.

It is appropriate that the round target contour of the at least one die part and the contour of the at least one other die part deviating from the round target contour are provided in one area of the front opening of the press die and in one area of the rear opening of the press die; the formation of the at least one die part and the at least one other die part is reversed with respect to their formation in the one area of the front opening. As a result, the press die has the asymmetrical arrangement of the round contour described above with respect to the contour deviating therefrom, both in the area of the front opening and in the area of the rear opening of the through-hole forming the die surface. This results in the advantages already described above in the area of the two openings. In addition, the press die can be manufactured easily, since at least one die part and at least one other die part can be identical parts. The press die can then be formed by arranging the identical die parts rotated by 180 degrees relative to each other.

It can be provided that the at least two die parts between one area of the front opening and one area of the rear opening contain a preferably groove-shaped recess in the respective circumferential section of the through-hole on the circumference, such that a peripheral recess is thereby formed in the through-hole of the press die. In particular, the recess is dimensioned in such a manner that the outer round tubular section of the workpieces to be pressed, which is, for example, part of a press fitting, can comprise a receptacle, in particular a groove, for receiving a sealing element, in particular a sealing ring, such as an O-ring. During pressing, the recess of the press die accommodates the fitting with the sealing ring arranged in it. A press connection can therefore be realized by means of the recess in the press die, with which an additional seal is realized between the connecting partners by the sealing ring. It is appropriate for the recess to be dimensioned in such a manner that, by pressing, the receptacle is pressed with the sealing element such that the sealing element is brought into a final sealing fit.

Instead of a two-part design of the press die, the press die can be constructed of at least three die parts in several parts. The press die then comprises, for example, at least one, preferably three, closing points, wherein each of the closing points is formed by mutually associated end faces of mutually adjacent die parts of the at least three die parts, and each of the at least three die parts comprises a circumferential section of the through-hole, such that, in a closing position of the at least three die parts at the closing points, the circumferential surface of the through-hole is assembled on the circumference. In this case, it can be provided that at least one of the die parts comprises the round target contour over at least one subsection of the associated circumferential section of the through-hole, and at least another of the die parts comprises the contour deviating from the round target contour over at least one subsection of the associated circumferential section of the through-hole, such that the circumferential sections of the through-hole associated with the at least three die parts are asymmetrical relative to each other with respect to a chord formed by the associated circumferential section of the through-hole. In this manner, the advantages described above for the press die constructed in two parts can also be achieved with a press die constructed in at least three parts.

For example, it is provided that the at least one die part comprises the round target contour and each of at least two other of the die parts comprises the contour deviating from the round target contour or each comprises a contour deviating from the round target contour. Alternatively, it can be provided that at least two of the die parts comprise the round target contour and at least one other of the die parts comprises the contour deviating from the round target contour or a contour deviating from the round target contour.

It can also be provided that each of the die parts comprises a receptacle, in particular a groove section for detachable mounting on a pressing tool. The respective receptacle can be provided on an outer circumference of the associated die part. Thereby, the die parts are formed as exchangeable parts. For fixing to the pressing tool, a fixing point or attachment point can be provided on each die part, for example to receive a clamping element, in particular a clamping pin.

As stated above, a basic press die, for example for a pressing tool for pressing round tubular sections of at least two workpieces, comprises a front side, a rear side and a through-hole extending from the front side to the rear side. In particular, the rear side is arranged opposite the front side. The through-hole comprises a front opening at the front side and a rear opening at the rear side. Furthermore, the through-hole comprises a circumferential surface, which is formed as a die surface and in particular serves as a mold for the workpieces to be pressed.

As further explained above, the press die is constructed in several parts by at least two die parts, in particular die segments, and comprises at least one, preferably two closing points. Each of the closing points is formed by mutually associated end faces of mutually adjacent die parts of the at least two die parts, and each of the at least two die parts comprises a circumferential section of the through-hole, preferably over an angle of circumference, such that, in a closing position of the at least two die parts at the closing points, the circumferential surface of the through-hole is assembled on the circumference.

According to one embodiment, it is provided that, with at least one of the die parts on a predominant part of the circumferential angle, the associated circumferential section of the through-hole has a contour, in particular an inside contour, with a uniform angle-related circumferential length or with an essentially uniform angle-related circumferential length and, on a remaining part of the circumferential angle, a proportionally greater circumferential length is formed. The term “angle-related circumferential length” refers in particular to the arc length in relation to the angle or circumferential angle, as the case may be, in which the arc length spans. If, for example, the contour is a round, especially circular contour, the inside contour is an arc. On the circular arc, the circumferential length, i.e. the arc length on the inside contour is proportional, in particular exactly proportional, to the circumferential angle that has been spanned.

In one arrangement, the circumferential length formed across each die part is proportional to the circumferential angle occupied by the respective die part. An additional arrangement is that each die part with this shape is followed by a die part of the press die, with which the angle-related circumferential length varies over the entire circumferential angle. For example, such an arrangement is achieved if the circumferential section in the die part with the fluctuating angle-related circumferential length is formed by a part of a hexagon. There, the angle-related circumferential length periodically fluctuates between a maximum value and a minimum value. The minimum value is reached at the point at which the corners of the hexagon point inwards. The maximum value is reached where the corners of the hexagon point outwards.

One aspect of the disclosure relates to a pressing tool, in particular for pressing round tubular sections of at least two workpieces. The pressing tool comprises a press die, in particular at least one arrangement and/or at least one embodiment of the press die described above.

The pressing tool can comprise at least two pressing jaws, wherein the at least two die parts of the press die are assigned to one of the pressing jaws each. For example, the pressing jaws can be swiveled against each other by means of a swivel connection, in order to be swiveled from an open position to a closed position. For example, the open position is used to pick up the workpiece between the die parts. In the closed position, for example, the die parts are in the closed position.

The die parts can be attached to the respective associated pressing jaws, in particular they can be attached detachably, or they can be formed on them. Provided that the die parts are detachably attached to the associated pressing jaws, the die parts are formed as interchangeable inserts. For this purpose, each of the die parts can comprise a groove section for detachable mounting on the pressing tool, wherein the respective groove section is provided on the outer circumference of the associated die part. The pressing tool can be formed as pressing pliers. Moreover, the pressing tool can be formed as a pressing ring. If the press die is constructed in three parts, for example if it has at least three die parts as described above, the pressing tool can be a pressing loop.

According to an additional aspect of the disclosure, a method is provided for producing a press connection of round tubular sections of at least two workpieces. With the method, a pressing tool of the type described above is provided. The round tubular sections of the workpieces are pushed into each other over an axial overlap area. The round tubular sections are then pressed against each other in the axial overlap area by means of the pressing tool.

According to an additional aspect of the disclosure, a method for manufacturing a press die, such as the press die described above, is also provided for. The method comprises the following steps:
i) Provision of a one-piece blank;
ii) Insertion of two holes into the blank in such a manner that a passage is produced through the holes through the blank and in each case one of the holes forms an entrance opening of the passage, wherein one of the holes has a round cross-section and the other hole has an angular cross-section, in particular a polygonal cross-section, and the hole with the round cross-section has an inside diameter that is greater than or essentially equal to the inside circumferential diameter of the hole with the angular cross-section or is of the same size;
iii) Division or separation, as the case may be, of the blank into at least two parts in the direction of the longitudinal axis of the passage, in particular along the longitudinal axis of the passage;
iv) Provision of at least one of the at least two parts as a die part for the press die.

The press die is thus produced from a one-piece blank that, after the hole with the round cross-section and the hole with the angular cross-section have been formed therein, is divided into at least two parts, wherein at least one of the parts is used as the die part for the press die. The division can be carried out by sawing or eroding, and is carried out along the longitudinal axis of the passage formed by the hole with the round cross-section and the hole with the angular cross-section, such that each of the parts has a circumferential section of the passage. This circumferential section forms part of a die surface of the press die. For example, the hole with the round cross-section and the hole with the angular cross-section are arranged coaxially relative to each other. In this case, the center axes of the two holes are on a common center axis.

Due to the hole with the angular cross-section, the circumferential section of the parts has a circumferential contour deviating from round over an area in the axial direction with respect to the longitudinal axis of the passage. When the press die is subsequently used, this area forms a contour on the round tubular sections of the workpieces to be pressed, which acts as an anti-rotation protection and promotes a rotationally rigid fit of the workpieces relative to each other. Through the hole with the round cross-section, the circumferential section of the parts has a circumferential contour over another area in the axial direction with respect to the longitudinal axis of the passage, which is based on the round cross-sectional shape of the workpieces to be pressed. Thus, at least in this other area, the pressing of the round tubular sections of the workpieces to be pressed can be achieved without a degree formation or at most only a slight degree formation.

By producing the passage through the blank in such a manner that one of the holes drilled for this purpose has a round cross-section, a turning tool, such as a lathe tool, can be used to form this hole. This, in turn, makes it easier to make an undercut, an annular groove, an indent or similar radial recess in the circumferential surface of the hole, since it is also possible to use a turning tool or the turning tool already used to form the hole.

As the hole with the round cross-section has an inside diameter that is greater than or essentially equal to or the same size as the inside circumferential diameter of the hole with the angular cross-section, the passage can be produced even if the smallest available turning tools have to be used to form the hole with the round cross-section, and such turning tools no longer permit the formation of a hole with a diameter that corresponds at most to the inscribed diameter of the hole with the angular cross-section to be inserted.

The one-piece blank provided can be a single piece; that is, it can be produced and/or formed from one piece. The hole with the round cross-section can have a circular cross-section. In principle, an oval cross-section is also possible. For example, the hole with the round cross-section is drilled, in particular by means of a turning tool. The hole with the round cross-section can be a blind hole. The term “blind hole” refers in particular to a hole that is made in the blank at a specified depth, without penetrating the blank completely. In contrast to this, with a through-hole, the hole is completely brought through the blank.

For example, the hole with the angular cross-section has a polygonal cross-section. The term “angular” means that the cross-section has at least one, preferably several, corners. The corners can also be rounded. The hole with the angular cross-section can be a blind hole or a through-hole. The hole with the angular cross-section can be milled with a milling cutter. The hole with the angular cross-section can have a cross-section formed as a hexagon. Moreover, the cross-section can be triangular, square, pentagonal, hexagonal, heptagonal or a further number of corners.

In particular, it is provided that the corners of the angular cross-section lie on a common circumference. This circumference is determined by the designation “circumferential diameter” already indicated above. On the other hand, the term “inscribed diameter” already mentioned above refers to the diameter of the inscribed circle. The inscribed circle is present with polygonal cross-sections or polygons, as the case may be, and describes the circle that touches all sides of the polygon in its interior.

For example, the method can also be carried out as follows: A one-piece blank is provided, which blank comprises a front side and a rear side that is preferably opposite the front side. From the front side, a first blind hole is drilled into the one-piece blank, for example using a turning tool. A second blind hole is then formed in the one-piece blank from the rear side, wherein the second blind hole extends into or at or over the first blind hole. A milling cutter can be used for this purpose.

Preferably, the cross-section of the second blind hole is shaped as a hexagon. Preferably, the center axis of the hexagon is arranged coaxially to the center axis of the first blind hole. It is also preferably provided that the inside circumferential diameter of the hexagon is equal or essentially equal to the inside diameter of the first blind hole.

The sequence of manufacturing the blind holes is arbitrary. It is also possible to insert the second blind hole first, and then the first blind hole into the blank. Finally, the one-piece blank is cut into at least two parts in the direction of the center axis of the first blind hole and/or the second blind hole, wherein the parts are then used or can be used as die parts of a press die, such as, for example, the press die described above.

According to an additional form of the method, it is provided that at least one undercut, annular groove, indent or similar radial recess is inserted into the circumferential surface of the hole with the round cross-section. For example, the radial recess is formed in such a manner that a workpiece, in particular a fitting, can be pressed by means of the press die, which comprises a ribbing on the circumference with a sealing ring accommodated therein. For example, the radial recess is arranged at an axial distance from one, preferably both, entrance openings of the passage.

For example, the press die can be manufactured by first inserting a through-hole in the blank, in particular by drilling, for example with a circular cross-section, wherein the diameter of such through-hole is smaller than the inscribed diameter of the hole with the angular cross-section. And only then the hole with the round cross-section and the hole with the angular cross-section are formed using the previously inserted through-hole.

A further additional form of the method is that a press die is provided, in which press die adjacent die parts of the die parts of the press die are arranged at a 180° foldover relative to each other. In other words, the adjacent parts of the die are arranged in a manner rotated 180° relative to each other around the transverse axis transverse to the longitudinal axis of the passage. This has the effect that, when the round tubular sections of workpieces are pressed, an asymmetrical deformation pattern is created on the pressed sections and the advantages already described above are achieved for this.

Further details and features of the invention arise from the following description of an exemplary embodiment based on the drawings.

### BRIEF DESCRIPTION OF THE DRAWINGS

FIG. 1 shows a possible embodiment of a pressing tool in perspective view.

FIG. 2 an enlarged view of the pressing tool of FIG. 1 in the area of a press die.

FIG. 3 shows a possible embodiment of a die part of a two-part press die, which can be used for example in the pressing tool of FIGS. 1 and 2, in perspective view.

FIG. 4 shows another die part of the press die corresponding to the die part in FIG. 3, in perspective view.

FIG. 5 shows the press die assembled by the die parts of FIGS. 3 and 4 in a view of the front side.

FIG. 6 shows the press die of FIG. 5 in a view of the rear side.

FIG. 7 shows a possible embodiment of a press die, comprising three die parts, in a view of the front side of the press die.

FIG. 8 shows the press die of FIG. 7 in a view of the rear side.

### DETAILED DESCRIPTION

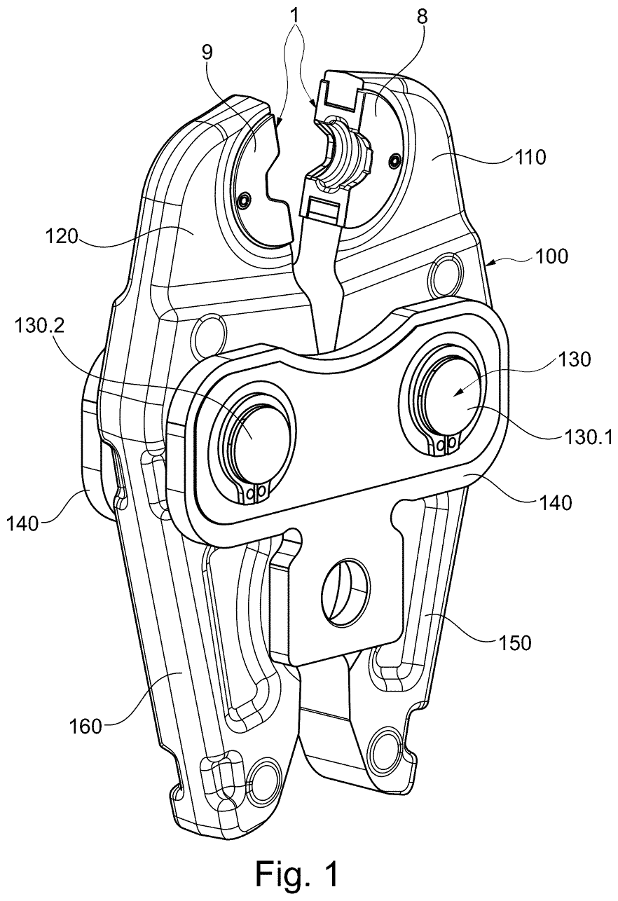

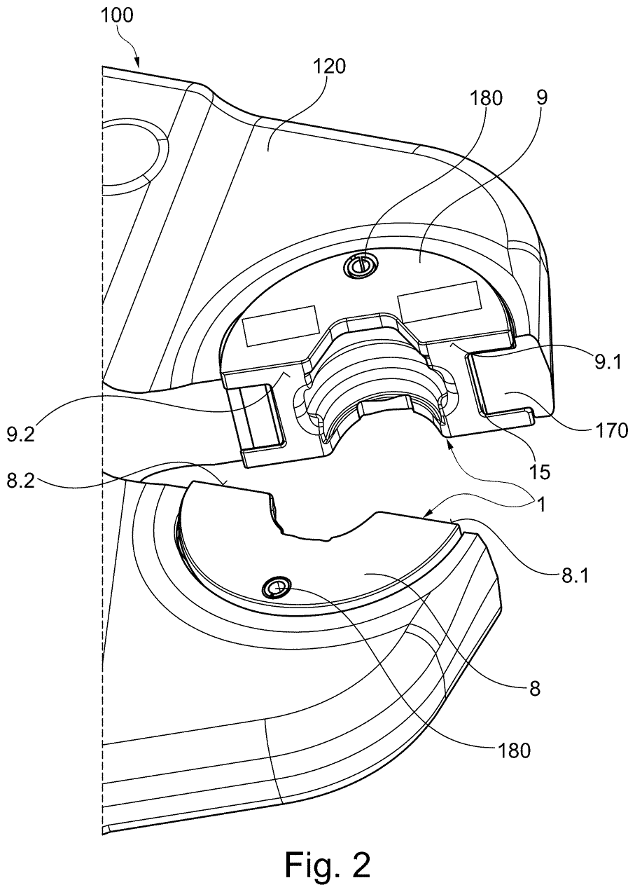

FIG. 1 shows—in schematic form—a possible embodiment of a pressing tool 100 in a perspective view. The pressing tool 100 has a press die 1, which is constructed in several parts. For example, press die 1 comprises two die parts 8 and 9. FIG. 2 shows the pressing tool 100 in an enlarged view in the area of the press die 1.

The pressing tool 100 is used for pressing round tubular sections of at least two workpieces. In particular, the pressing tool 100 can be used to press tubular, in particular round tubular workpieces to form an undetachable tube connection. For example, one of the workpieces is a tube or tube section, as the case may be, and another of the workpieces is a press fitting, for example a tube socket, which is pressed against the tube using the pressing tool 100.

The pressing tool 100 has two pressing jaws 110, 120, wherein one of the pressing jaws 110 and 120 is assigned to one of the die parts 8 or 9, as the case may be, respectively. The pressing jaws 110 and 120 can be swiveled against each other by means of a swivel joint 130, in order to be swiveled relative to each other from an open position, as shown in FIGS. 1 and 2, to a closed position. The open position is used, for example, to pick up the workpieces to be pressed between the die parts 8 and 9. In the closed position, for example, the die parts 8 and 9 are in a closed position relative to each other. The swivel joint 130 can comprise at least one intermediate part 140, on which one of the pressing jaws 110 and 120 is rotatably mounted via a shaft or axle 130.1 and 130.2.

The die parts 8 and 9 of the press die 1 can be detachably attached to the respective associated pressing jaws 110 or 120, as the case may be. In this respect, the die parts 8 and 9 can be formed as interchangeable inserts. For this purpose, an annular groove 15 can be provided on the outer circumference of the press die 1, which is preferably formed on each of the die parts 8 and 9, in order to be able to insert the respective die part 8 and 9 on the associated pressing jaws 110 or 120, as the case may be, respectively in a correspondingly provided projection 170. The annular groove 15 and the projection 170 secure the die components 8 and 9 in the respective associated pressing jaw 110 or 120, as the case may be, against the lateral sliding out of a fastening position on the associated pressing jaw 110 or 120, as the case may be.

Preferably, at least one additional coiled spring pin element 180 is used to clamp the respective die part 8 or 9, as the case may be, at the associated pressing jaw 110 or 120, as the case may be, in a force-fitting manner or to fix it by means of positive locking, in order to avoid loosening from the fixing position at the associated pressing jaw 110 or 120, as the case may be, in the radial direction. For this purpose, at least one fixing point 8.6 or 9.6, as the case may be, in particular a receptacle opening for the coiled spring pin element 180, can be provided on the respective die part 8 or 9, as the case may be. Alternatively, the die parts 8 and 9 can also be permanently attached to the respective pressing jaw 110 or 120, as the case may be, for example by forming the die parts 8 and 9 on the respective pressing jaw 110 or 120, as the case may be.

Preferably, the pressing tool 100 can be coupled with a drive unit (not shown in FIGS. 1 and 2), in particular mechanically coupled, to move pressing jaws 110, 120 from the open position to the closed position. The drive unit can be a manually actuated drive unit or a drive unit actuated by an electric motor or by hydraulic or pneumatic means. The actuating force generated by the actuating device moves the pressing jaws 110, 120 relative to each other. For this purpose, each the pressing jaws 110 and 120 can have a rear part 150 and 160, through which the pressing jaws 110 and 120 are extended backwards, in particular away from the area of the die parts 8 and 9, and each of which forms a lever in relation to the articulated joint 130. As such, it is preferable for at least one coupling point for the actuating device to be provided on each of the rear parts 150 and 160.

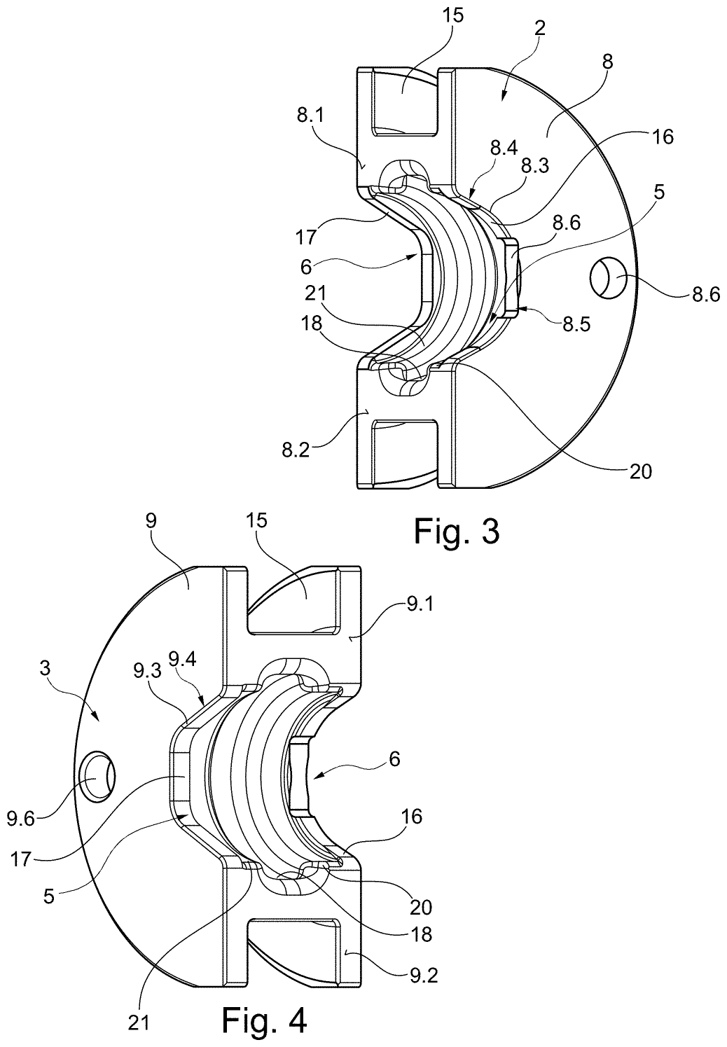

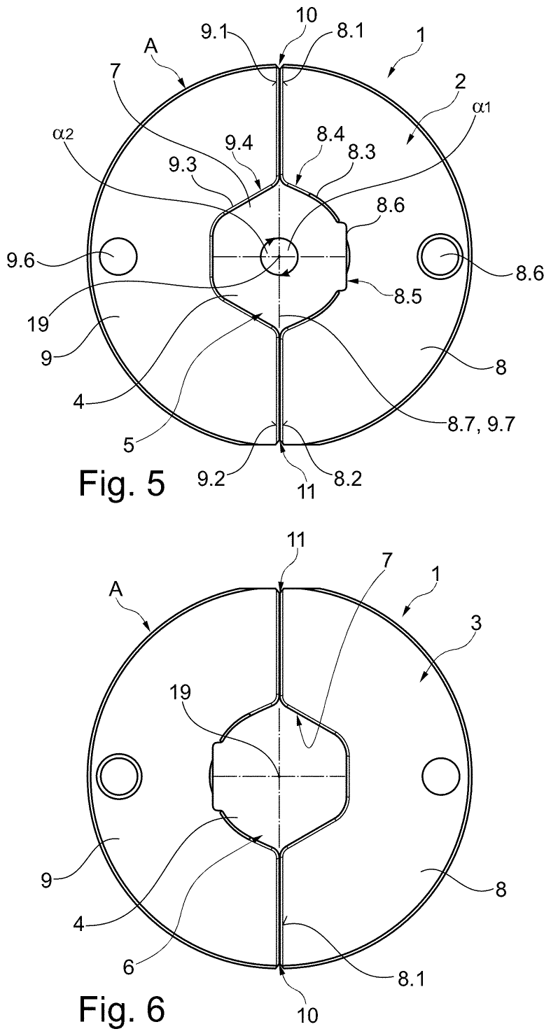

The structure and design of the press die 1 is described in more detail below on the basis of FIGS. 3 to 6. FIG. 3 shows the die part 8 in a perspective view. FIG. 4 likewise shows the die part 9 in a perspective view. FIGS. 5 and 6 show the press die 1 with the die parts 8 and 9 in a front view (FIG. 5) and a rear view (FIG. 6).

The press die 1 comprises a front side 2, a preferably opposite rear side 3 and a through-hole 4 extending from the front side 2 to the rear side 3. The through-hole 4 comprises a front opening 5 on the front side 2 and a rear opening 6 on the rear side 3 along with a circumferential surface 7, which is formed as a die surface. The designations “front” and “back” are arbitrarily chosen and could therefore be exchanged. The same applies to the indications “front” and “rear” in relation to openings 5 and 6.

In addition to the two die parts 8 and 9, which can also be designated as the first die part 8 and second die part 9, the press die 1 comprises two closing points 10 and 11. Each of the closing points 10 and 11 is formed by mutually associated end faces 8.1, 9.1 along with 8.2, 9.2 of the die parts 8, 9, wherein each of the two die parts 8, 9 comprises a circumferential section of the through-hole 4 via a circumferential angle α1, α2, such that, in the closing position A of the two die parts 8, 9 already described above, the circumferential surface 7 of the through-hole 4 is assembled at the closing points 10, 11 on the circumference.

As can be seen from the example in FIG. 5, one of the die parts 8, 9, for example the die part 8, has a round target contour 8.3 over at least one subsection 8.4 of the circumferential section of the through-hole 4, which belongs to the one of the die parts 8, 9. By contrast, the other die part, in particular the die part 9, has a contour 9.3 deviating from the round target contour 8.3 over at least one subsection 9.4 of the circumferential section of the through-hole 4, which is assigned to such other die part 9. The at least one subsection 8.4 with the round target contour 8.3 and the at least one subsection 9.4 with the deviating contour 9.3 are arranged in such a manner that the circumferential sections of the through-hole 4 associated with the two die parts 8, 9 are asymmetrical relative to each other with respect to a chord 8.7, 9.7 formed by the associated circumferential section of the through-hole 4. Preferably, the areas 8.3 and 9.3 are arranged adjacent to end faces 8.1 and 9.1 respectively.

The round target contour 8.3 can be formed to be circular or at least have a section of a circular arc. For example, contour 9.3 that deviates from the round target contour 8.3 is formed to be straight. For example, the contour 9.3, which differs from the round target contour 8.3, forms at least one side of a polygon, wherein at least part of the polygon forms the circumferential section of the through-hole 4, which is enclosed by the associated die part 9. For example, the polygon is a hexagon, in particular a rounded hexagon, and the circumferential section of the through-hole 4, which is formed by the associated die part 9, comprises three sides of the hexagon, as can be seen in particular in FIG. 5. In particular, the inside circumferential radius of the hexagon corresponds to the inside radius of the round contour 9.3 in relation to the center axis 19 of the press die 1.

The round target contour 8.3 can be interrupted by an area 8.5 with an additional contour 8.8 deviating from it. The additional contour 8.8 can likewise be a contour formed to be straight. For example, the additional contour 8.8 is arranged parallel to and spaced apart from the chord 8.7 of the corresponding die part 8. The die part 9 with the additional contour 8.8 can also be described in a generalized manner by the fact that, on a predominant part of the circumferential angle α1, the associated circumferential section of the through-hole 4 has a contour with a uniform angle-related circumferential length and, on a remaining part of the circumferential angle α1, a proportionally greater circumferential length is formed. The angle-related circumferential length refers to the arc length in relation to the circumferential angle in which the arc length of the die part 8 is spanned.

Preferably, the round target contour 8.3 and the contour 9.3 deviating from it are provided in an area 16 of the front opening 5 of the press die 1, and in an area 17 of the rear opening 6 of the press die 1, the formation of the die parts 8 and 9 is reversed compared to their formation in one area of the front opening 5. In this respect, the arrangement of the die parts 8 and 9 results in the area 17 of the rear opening 6, as shown in FIG. 6. As such, the die parts 8 and 9 are preferably formed as identical parts.

Preferably, the circumferential surface 7 of the press die 1, which serves as the die surface, has an annular recess 12, in particular an annular groove, between the area 16 of the front opening 5 and the area 17 of the rear opening 6. The recess 12 is used to press a workpiece, such as, for example, a press fitting, which contains a peripheral ribbing with a sealing ring accommodated therein. In this respect, the recess 12 is preferably adapted to the dimensions of this circumferential ribbing on the workpiece.

The circumferential surface 7 of the press die can be distributed between one area 16 of the front opening 5 and one area 17 of the rear opening 6, such that each of the area 16 and the area 17 forms a constriction, i.e. a projection extending in a radial direction inwards, with respect to the circumferential surface 7 of the press die 1; that is, the surfaces 20, 21 adjacent to the areas 16, 17 are preferably slightly set back radially.

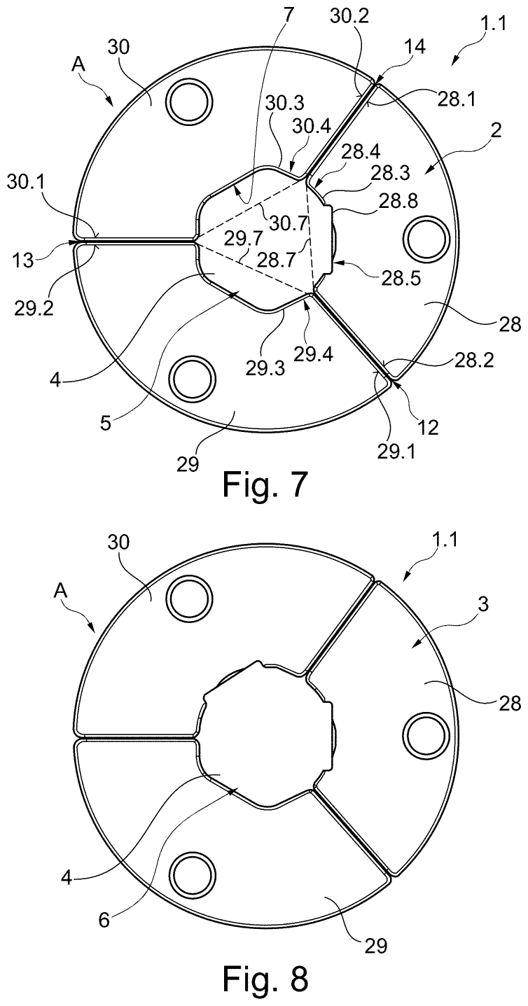

FIG. 7 shows an additional possible embodiment of a press die 1.1. The press die 1.1 differs from press die 1 of FIGS. 3 to 6, among other things, in that press die 1.1 is constructed by three die parts 28, 29, 30. The die parts 28, 29, 30 can also be designated as the first die part 28, the second die part 29 and the third die part 30. FIG. 7 shows the press die 1.1 in a view of the front side 2. FIG. 8 shows the press die 1.1 in a view of the rear side 3. The press die 1.1 comprises three closing points 12, 13, 14, wherein each of the closing points 12, 13, 14 is formed by end faces 28.2, 29.1 or 29.2, 30.1 or 30.2, 28.1, as the case may be, which are associated relative to each other, of die parts 28, 29 or 29, 30 or 30, 28, as the case may be, of the three die parts 28, 29, 30, which are adjacent relative to each other, and each of the die parts 28, 29, 30 comprises a circumferential section of the through-hole 4, such that, in the closed position A of the die parts 28, 29, 30 at the closing points 12, 13, 14, the circumferential surface 7 of the through-hole 4 is assembled on the circumference.

As can be seen in FIG. 7, one of the die parts 28, 29, 30, in particular the die part 28, has a round target contour 28.3 over at least one subsection 28.4 of the associated circumferential section of the through-hole 4. Each of the other of the die parts 28, 29 30, in particular the die parts 29, 30, has a contour 29.3 or 30.3, as the case may be, deviating from the round target contour 28.3 over at least one subsection 29.4 or 30.4, as the case may be, of the associated circumferential section of the through-hole 4, such that the three die parts 28, 29 and 30 of associated circumferential sections of the through-hole 4 are asymmetrical relative to each other with respect to a chord 28.7, 29.7, 30.7 formed by the associated circumferential section.

The round target contour 28.3 of the press die 1.1 can also be formed to be circular. Preferably, the contour 29.3 or 30.3, as the case may be, deviating from this is formed in a straight line; for example, it is formed by a part of a polygon. Preferably, the deviating contour 29.3 or 30.3, as the case may be, is formed at least partially by three sides of a hexagon. The round target contour 8.3 can be interrupted by one area 28.5 with an additional contour 28.8 deviating from it. The additional contour 28.8 can also be a contour that is formed straight. The die parts 28, 29, 30 of the press die 1.1 are preferably formed as identical parts. This results in the arrangement with respect to the reverse side 3 of the press die 1, which is shown in FIG. 8.

### LIST OF REFERENCE SIGNS

1 Press die
1.1 Press die
2 Front side
3 Rear side
4 Through-hole
5 Front opening
6 Rear opening
7 Circumferential surface
8 Die part (first die part)
8.1 End face
8.2 End face
8.3 Round target contour
8.4 Subsection
8.5 Area
8.6 Fixing point
8.7 Chord
8.8 Additional contour
9 Die part (second die part)
9.1 End face
9.2 End face
9.3 Deviating contour
9.4 Area
9.6 Fixing point
9.7 Chord
10 Closing point
11 Closing point
12 Closing point
13 Closing point
14 Closing point
15 Ring groove
16 Area
17 Area
18 Recess
19 Center axis
20 Surface
21 Surface e
28 Die part (first die part)
28.1 End face
28.2 End face
28.3 Round target contour
28.4 Subsection
28.5 Area
28.7 Chord
28.8 Additional contour
29 Die part (second die part)
29.1 End face
29.2 End face
29.3 Deviating contour
29.4 Sub section
29.7 Chord
30 Die part (third die part)
30.1 End face
30.2 End face
30.3 Deviating contour
30.4 Subsection
30.7 Chord
100 Pressing tool
110 Pressing jaw
120 Pressing jaw
130 Articulated joint
130.1 Axis
130.2 Axis
140 Intermediate section
150 Rear part
160 Rear part
170 Projection
180 Coiled spring pin element
A Closing position
α1 Circumferential angle
α2 Circumferential angle

1.-19. (canceled)

20. A press die (1) for a pressing tool (100) for pressing round tubular sections of at least two workpieces, comprising:
a front side (2);
a rear side (3); and
a through-hole (4) extending from the front side (2) to the rear side (3), the through-hole (4) comprising
a front opening (5) on the front side (2),
a rear opening (6) on the rear side (3), and
a circumferential surface (7), which is formed as a die surface,
wherein the press die (1) is constructed of multiple parts including at least two die parts (8, 9) and comprises two closing points (10, 11),
wherein each of the closing points (10, 11) is formed by mutually associated end faces (8.1, 8.2, 9.1, 9.2) of mutually adjacent die parts (8, 9) of the at least two die parts (8, 9), and
wherein each of the at least two die parts (8, 9) comprises a circumferential section of the through-hole (4), such that, in a closed position (A) of the at least two die parts (8, 9) at the closing points (10, 11), the circumferential surface (7) of the through-hole (4) is assembled on the circumference,
wherein
at least one of the at least two die parts (8, 9) comprises a round target contour (8.3) over at least one subsection (8.4) of an associated circumferential section of the through-hole (4) and
at least one other die part (9) of the at least two die parts comprises a contour (9.3) deviating from the round target contour (8.3) over at least one other subsection (9.4) of the associated circumferential section of the through-hole (4),
such that the circumferential sections of the through-hole (4) associated with the at least two die parts (8, 9) are asymmetrical relative to each other with respect to a chord (8.7, 9.7) formed by an associated circumferential section of the through-hole (4).

21. The press die according to claim 20,
wherein the contour (9.3) deviating from the round target contour (8.3) is straight.

22. The press die according to claim 20,
wherein the contour (9.3) deviating from the round target contour (8.3) forms at least one side of a polygon, and
wherein at least one part of the polygon forms the circumferential section of the through-hole (4), which is enclosed by the at least one other die part (9).

23. The press die according to claim 22,
wherein the polygon is a hexagon and the circumferential section of the through-hole (4) formed by the at least one other die part (9) at least partially comprises at least three sides of the hexagon.

24. The press die according to claim 20,
wherein the round target contour (8.3) is interrupted by an area (8.5) with an additional contour (8.8) deviating from the round target contour (8.3).

25. The press die according to claim 24,
wherein the additional contour (8.8) deviating from the round target contour (8.3) is straight and is arranged parallel to and spaced apart from the chord (8.7) of the associated at least one die part (8).

26. The press die according to claim 20,
wherein the at least one subsection (8.4) adjoins one of the mutually associated end faces (8.1, 8.2) of the at least one die part (8), and
wherein the at least one other subsection (9.4) adjoins the corresponding end face (9.1) of the at least one other die part (9).

27. The press die according to claim 20,
wherein the round target contour (8.3) of the at least one die part (8) and the contour (9.3) of the at least one other die part deviating from the round target contour (8.3) are provided in an area of the front opening (5) of the press die (1) and
wherein in an area of the rear opening (6) of the press die (1) a formation of the at least one die part (8) and the at least one other die part (9) is reversed with respect to a formation in the area of the front opening (5).

28. The press die according to claim 27,
wherein the at least two die parts (8, 9) between the area of the front opening (5) and the area of the rear opening (6) contain a groove-shaped recess (12) in the respective circumferential section of the through-hole (4) on the circumference.

29. The press die according to claim 27,
wherein the at least one die part (8) and the at least one other die part (9) are common parts.

30. A press die (1.1) for a pressing tool (100) for pressing round tubular sections of at least two workpieces, comprising:
a front side (2);
a rear side (3); and
a through-hole (4) extending from the front side (2) to the rear side (3), the through-hole (4) comprising
a front opening (5) on the front side (2),
a rear opening (6) on the rear side (3), and
a circumferential surface (7), which is formed as a die surface,
wherein the press die (1.1) is constructed of multiple parts including at least three die parts (28, 29, 30) and comprises at least three closing points (12, 13, 14),
wherein each of the at least closing points (12, 13, 14) is formed by mutually associated end faces (28.2, 29.1; 29.2, 30.1; 30.2, 28.1) of mutually adjacent die parts (28, 29; 29, 30; 30, 28) of the at least three die parts (28, 29, 30) adjacent to each other, and
wherein each of the at least three die parts (28, 29, 30) comprises a circumferential section of the through-hole (4), such that, in a closed position (A) of the at least three die parts (28, 29, 30) at the at least three closing points (12, 13, 14), the circumferential surface (7) of the through-hole (4) is assembled on the circumference,
wherein
at least one of the die parts (28, 29, 30) comprises the round target contour (28.3) over at least one subsection (28.4) of the associated circumferential section of the through-hole (4) and
at least one other of the die parts (28, 29, 30) comprises the contour (29.3) deviating from the round target contour (28.3) over at least one subsection (29.4) of the associated circumferential section of the through-hole (4),
such that the circumferential sections of the through-hole (4) associated with the at least three die parts (28, 29, 30) are asymmetrical relative to each other with respect to a chord (28.7, 29.7, 30.7) formed by the associated circumferential section.

31. The press die according to claim 30,
wherein the at least one die part (28) comprises the round target contour (28.3), and each of at least two other of the die parts (28, 29, 30) comprises the contour (29.3, 30.3) deviating from the round target contour (28.3).

32. A press die (1) for a pressing tool (100) for pressing round tubular sections of at least two workpieces, comprising:
a front side (2);
a rear side (3); and
a through-hole (4) extending from the front side (2) to the rear side (3), the through-hole (4) comprising
a front opening (5) on the front side (2),
a rear opening (6) on the rear side (3), and
a circumferential surface (7), which is formed as a die surface,
wherein the press die (1) is constructed in several parts including at least two die parts (8, 9) and comprises at least two closing points (10, 11),
wherein each of the at least two closing points (10, 11) is closed by mutually associated end faces (8.1, 8.2, 9.1, 9.2) of mutually adjacent die parts (8, 9) of the at least two die parts (8, 9), and
wherein each of the at least two die parts (8, 9) comprises a circumferential section of the through-hole (4) over a circumferential angle (α1, α2), such that, in a closed position (A) of the at least two die parts (8, 9) at the at least two closing points (10, 11), the circumferential surface (7) of the through-hole (4) is assembled on the circumference,
wherein, with at least one of the die parts (8, 9) on a predominant part of the circumferential angle (α1), the associated circumferential section has a contour (8.3) with an essentially uniform angle-related circumferential length and, on a remaining part of the associated circumferential angle (α1), a proportionally greater circumferential length is formed.

33. The press die according to claim 32,
wherein the circumferential length formed across the die parts (8, 9) is proportional to the circumferential angle (α1, α2) occupied by the respective die part (8, 9).

34. The press die according to claim 32,
wherein adjoining the at least one die part (8) is a die part (9), with which the angle-related circumferential length varies over the associated circumferential angle (α2).

35. A pressing tool (100) for pressing round tubular sections of at least two workpieces,
wherein the pressing tool (100) comprises the press die (1; 1.1; 1.2) according to claim 20.

36. A method for producing a press connection of round tubular sections of at least two workpieces, comprising the steps:
i) providing the pressing tool (100) according to claim 35;
ii) sliding the round tubular sections of the workpieces into each other over an axial overlap area; and
iii) pressing the round tubular sections in the axial overlap area by means of the pressing tool (100).
